(19) United States
(12) Patent Application Publication
(10) Pub. No.: US 2026/0042147 A1
(43) Pub. Date: Feb. 12, 2026

(54) MACHINE LEARNING THERMAL MANAGEMENT SYSTEM FOR ADDITIVE MANUFACTURING

(71) Applicant: VIRGINIA TECH INTELLECTUAL PROPERTIES, INC., Blacksburg, VA (US)

(72) Inventors: Rongxuan Wang, Blacksburg, VA (US); Ruixuan Wang, Blacksburg, VA (US); Zhenyu Kong, Blacksburg, VA (US); Anbo Wang, Blacksburg, VA (US)

(21) Appl. No.: 19/295,958

(22) Filed: Aug. 11, 2025

Related U.S. Application Data
(60) Provisional application No. 63/681,222, filed on Aug. 9, 2024.

(51) Int. Cl. B22F 10/85; B22F 10/28; B22F 10/31; B22F 12/90; B33Y 10/00; B33Y 30/00; B33Y 40/20; B33Y 50/02; G01K 7/42; G01K 11/3206; G01K 15/00; G06N 3/048; G06N 3/08

(52) U.S. Cl. CPC B22F 10/85; B22F 10/28; B22F 10/31; B22F 12/90; B33Y 10/00; B33Y 30/00; B33Y 40/20; B33Y 50/02; G01K 7/427; G01K 11/3206; G01K 15/002; G01K 15/005; G06N 3/048; G06N 3/08; B22F 2203/11

(57) ABSTRACT

A thermal measurement system enables high-resolution sub-surface temperature monitoring during additive manufacturing processes through machine learning demodulation of chirped fiber Bragg grating (C-FBG) sensors. An optical sensing subsystem includes a C-FBG sensor that encodes spatial temperature information in wavelength for high-temperature operation. A neural network model transforms complex reflection spectra into spatial temperature profiles with micrometer-scale resolution, overcoming limitations of traditional demodulation methods. A calibration subsystem generates synchronized spectral and thermal imaging data for training the neural network using controlled thermal profiles. The system captures steep thermal gradients and rapid cooling rates during laser powder bed fusion operations. A fiber embedding technique maintains the sensor in a strain-free condition at controlled sub-surface depths. The integration of high-temperature C-FBG sensors with machine learning signal processing achieves significant improvement in spatial resolution compared to traditional fiber optic thermal measurement approaches.

### CROSS-REFERENCE TO RELATED APPLICATION

This application claims priority to and the benefit of U.S. Provisional Patent Application No. 63/681,222 filed Aug. 9, 2024, titled “Fiber Optics With Extra High Spatial Resolution Enabled By Machine Learning For Sub-Surface Thermal Measurement In Additive Manufacturing Processes,” the entire contents of which is hereby incorporated herein by reference.

### GOVERNMENT LICENSE RIGHTS

This invention was made with government support under Grant No. DE-SC0023984 awarded by the United States Department of Energy. The government has certain rights in the invention.

### BACKGROUND

Laser powder bed fusion (L-PBF) is an additive manufacturing technique that enables fabrication of metal parts with complex geometries. Despite its potential, achieving consistent production of defect-free parts remains challenging. The mechanical performance of L-PBF parts depends on their microstructures, including grain size, orientation, and boundaries. These microstructures evolve through complex thermal cycles during layer-by-layer fabrication, making their control critical to part quality.

Existing approaches to studying microstructure formation face significant limitations. Some research focuses on single-track melting due to measurement constraints. However, actual L-PBF processes involve repeated thermal cycling as deposited layers experience re-melting from subsequent layers. Without direct measurement capabilities, researchers rely on finite element analysis (FEA) and computational fluid dynamics (CFD) models that suffer from high computational costs and inaccuracies due to simplified assumptions.

The extreme L-PBF conditions create challenges for thermal measurement. High-speed laser scanning generates microscale melt pools that solidify within milliseconds. The process produces steep thermal gradients and rapid cooling rates that directly influence microstructure formation. Capturing these dynamics requires high spatial and temporal resolution. While high-speed infrared cameras can achieve the necessary specifications for surface monitoring, these cameras cannot provide sub-surface thermal data needed for understanding bulk microstructure evolution.

Traditional temperature sensors present additional limitations. Thermocouple arrays lack the spatial resolution necessary for monitoring the region surrounding the melt pool and create mechanical discontinuities when embedded. The extreme temperatures of metals with high melting points challenge sensor durability. Existing fiber optic solutions, including optical frequency domain reflectometry (OFDR) and traditional fiber Bragg gratings (FBGs), are limited to millimeter-level spatial resolution, which is insufficient for capturing the steep thermal gradients characteristic of L-PBF processes.

The absence of a measurement technique providing high spatial resolution, high temporal resolution, and sub-surface thermal data in the extreme L-PBF environment represents a significant technology gap. This capability would enable validation of process models and development of closed-loop control systems for L-PBF processes.

### SUMMARY

This Summary introduces a selection of concepts in a simplified form that are further described below in the Detailed Description. As such, this Summary is not intended to identify essential features of the claimed subject matter, nor is it intended to be used as an aid in determining the scope of the claimed subject matter.

A system of one or more computers can be configured to perform particular operations or actions by virtue of having software, firmware, hardware, or a combination thereof installed on the system that in operation causes or cause the system to perform the actions. One or more computer programs can be configured to perform particular operations or actions by virtue of including instructions that, when executed by data processing apparatus, cause the apparatus to perform the actions. One general aspect includes a thermal measurement system for additive manufacturing processes. The thermal measurement system also includes an optical sensing subsystem may include a chirped fiber Bragg grating (C-FBG) sensor configured to encode spatial temperature information in a reflection spectrum. The system also includes a machine learning subsystem may include a neural network model configured to demodulate complex reflection spectra from the C-FBG sensor to generate spatial temperature profiles. The system also includes a calibration subsystem configured to generate training data by creating controlled thermal profiles on the C-FBG sensor while simultaneously capturing reference temperature measurements. The system also includes a data acquisition system configured to capture reflection spectra from the C-FBG sensor during additive manufacturing operations. Other embodiments of this aspect include corresponding computer systems, apparatus, and computer programs recorded on one or more computer storage devices, each configured to perform the actions of the methods.

Implementations may include one or more of the following features. The thermal measurement system where the C-FBG sensor is inscribed using a femtosecond laser point-by-point method. The C-FBG sensor is configured to operate at temperatures up to 1000 degrees Celsius (° C.). The spatial temperature profiles have a spatial resolution of at least 28.8 micrometers (μm) per pixel. The optical sensing subsystem may include a broadband light source, a fiber coupler configured to direct light to the C-FBG sensor and collect reflected light, a polarization scrambler configured to minimize polarization-dependent variations in the reflection spectrum, and a high-speed spectrometer configured to analyze the reflection spectrum. The high-speed spectrometer operates at a sampling rate of at least 10 kilohertz (kHz). The high-speed spectrometer has a maximum sampling rate of 70 kHz. The neural network model may include a fully-connected neural network with at least three hidden layers. The neural network model employs a rectified linear unit (ReLU) activation function and is optimized using stochastic gradient descent. The stochastic gradient descent uses a learning rate of 8e-2 and a batch size of 50. The calibration subsystem may include a translation stage configured to position a heat source relative to the C-FBG sensor, a heat source configured to create controlled thermal profiles, a reference infrared camera configured to capture ground truth thermal measurements, and a synchronization module configured to coordinate simultaneous acquisition of spectral and thermal data. The translation stage has a positioning resolution of at least 1 μm. The heat source may include a resistive heating element capable of generating temperatures from ambient to 800° C., for example. The thermal measurement system may include a laser powder bed fusion (L-PBF) integration subsystem may include a fiber embedding apparatus configured to install the C-FBG sensor within build substrates. The fiber embedding apparatus may include a wire electrical discharge machining system configured to create a slot in a substrate, a metallic wire configured to fill a gap between the C-FBG sensor and the substrate, and a laser powder bed fusion system configured to encapsulate the C-FBG sensor by melting a powder layer over a combination of the substrate, the metallic wire, and the C-FBG sensor.

In some implementations, the slot has a width of approximately 300 μm and a depth of approximately 355 μm, the metallic wire has a rectangular cross-section, and the powder layer has a thickness of approximately 100 μm. Implementations of the described techniques may include hardware, a method or process, or computer software on a computer-accessible medium.

One general aspect includes a method for thermal measurement in additive manufacturing processes. The method also includes generating broadband optical radiation. The method also includes directing the broadband optical radiation through a C-FBG sensor having a chirped grating structure that encodes spatial position information in wavelength. The method also includes detecting thermal events in a sub-surface region of a build substrate during additive manufacturing. The method also includes capturing a reflection spectrum from the C-FBG sensor, where the reflection spectrum contains spatially-encoded temperature information. The method also includes preprocessing the reflection spectrum to generate a fixed-dimension input array. The method also includes applying a neural network model to transform the reflection spectrum into a spatial temperature profile. The method also includes outputting thermal measurements with micrometer-scale spatial resolution. Other embodiments of this aspect include corresponding computer systems, apparatus, and computer programs recorded on one or more computer storage devices, each configured to perform the actions of the methods.

Implementations may include one or more of the following features. The method where the micrometer-scale spatial resolution is at least 28.8 μm per pixel. The method may include training the neural network model by creating varied thermal profiles on the C-FBG sensor using a moveable heat source, simultaneously capturing C-FBG reflection spectra and reference thermal images, generating paired training datasets of spectra and corresponding thermal profiles, and optimizing neural network parameters to minimize prediction error. The method may include embedding the C-FBG sensor in a substrate by creating a slot in the substrate using wire electrical discharge machining, positioning the C-FBG sensor within the slot, filling a gap above the C-FBG sensor with a metallic wire, applying a powder layer over a combination of the substrate, the metallic wire, and the C-FBG sensor, melting the powder layer using laser powder bed fusion, and polishing a surface of the substrate to complete the embedding while maintaining the sensor in a strain-free condition. Implementations of the described techniques may include hardware, a method or process, or computer software on a computer-accessible medium.

### BRIEF DESCRIPTION OF THE DRAWINGS

FIG. 1 depicts a thermal measurement system for high spatial resolution sub-surface thermal measurement in additive manufacturing processes according to an example implementation.

FIG. 2 depicts a method for high spatial resolution thermal measurement in additive manufacturing processes using the thermal measurement system of FIG. 1 according to an example implementation.

FIG. 3 depicts a cross-sectional view of a fiber embedding configuration according to an example implementation.

FIG. 4A depicts the operating principle of traditional fiber Bragg gratings (FBG) sensors for temperature measurement.

FIG. 4B depicts a chirped fiber Bragg gratings (C-FBG) sensor configuration demonstrating continuous spatial temperature measurement capabilities.

FIG. 4C depicts an experimental C-FBG reflection spectrum acquired from a femtosecond laser point-by-point (fs-PbP) inscribed sensor.

FIG. 5A depicts a thermal profile visualization generated during calibration of the thermal measurement system of FIG. 1 according to an example implementation.

FIG. 5B depicts a corresponding C-FBG reflection spectrum visualization acquired simultaneously with the thermal profile data of FIG. 5A.

FIG. 6A depicts a hidden layer optimization graph for a neural network model.

FIG. 6B depicts a batch size optimization graph for training the neural network model

FIG. 6C depicts a training loss convergence graph showing the optimization progress of the neural network model.

FIG. 6D depicts a correlation plot comparing predicted temperatures from the neural network model against actual temperatures measured by a reference infrared camera.

FIG. 7A depicts an experimental thermal profile visualization acquired during validation testing of the thermal measurement system of FIG. 1.

FIG. 7B depicts a machine learning-demodulated thermal profile visualization generated by the neural network model from C-FBG spectral data acquired simultaneously with the experimental data of FIG. 7A.

FIGS. 7C-7E depict comparative thermal profiles showing validation of the neural network model performance.

FIG. 8 depicts a sub-surface thermal measurement visualization acquired during laser powder bed fusion processing using the thermal measurement system of FIG. 1.

### DETAILED DESCRIPTION

The present disclosure relates to high spatial resolution thermal measurement systems for additive manufacturing processes. The mechanical properties and performance of additive manufactured (AM) metal parts depend on their microstructures. During layer-wise additive manufacturing, microstructure evolution involves complex re-melting and reheating effects as successive layers are deposited. Current approaches to studying these phenomena rely on computational models including Finite Element Analysis (FEA) and Computational Fluid Dynamics (CFD), which require experimental validation through direct thermal measurements.

The present disclosure provides a measurement system utilizing chirped fiber Bragg grating (C-FBG) sensors combined with machine learning signal processing. C-FBG sensors offer advantages in response rate and sensing frequency for sub-surface temperature measurement. While traditional demodulation methods limit C-FBG spatial resolution to the millimeter level, the disclosed machine learning approach achieves micrometer level spatial resolution. The disclosure further provides embedding techniques that preserve part integrity while ensuring reliable thermal contact between the sensor and surrounding material.

Fiber optic sensors provide several advantages for in-situ monitoring of additive manufacturing processes. These sensors operate by analyzing changes in optical signals transmitted through the fiber. When light with a known spectrum propagates through the fiber, variations in the reflection or transmission spectrum indicate physical parameters including temperature, strain, vibration, and bending. With typical diameters between 100 and 300 μm, fiber optic sensors can be embedded with minimal impact on part structure. The optical measurement principle provides high sensitivity and immunity to electromagnetic interference.

Two primary categories of fiber optic sensors have been applied to additive manufacturing: distributed sensors using optical frequency domain reflectometry (OFDR) and point sensors such as fiber Bragg gratings (FBGs). OFDR systems provide distributed measurements along the fiber length but are limited to millimeter level spatial resolution due to modulation bandwidth constraints and trade-offs between spatial sampling and measurement frequency. Traditional FBG sensors offer localized measurements with high sensitivity but require grating lengths of several millimeters, limiting the ability of FBG sensors to resolve steep thermal gradients. Previous implementations have demonstrated temperature and strain monitoring but lack the spatial resolution necessary for characterizing thermal fields near melt pools.

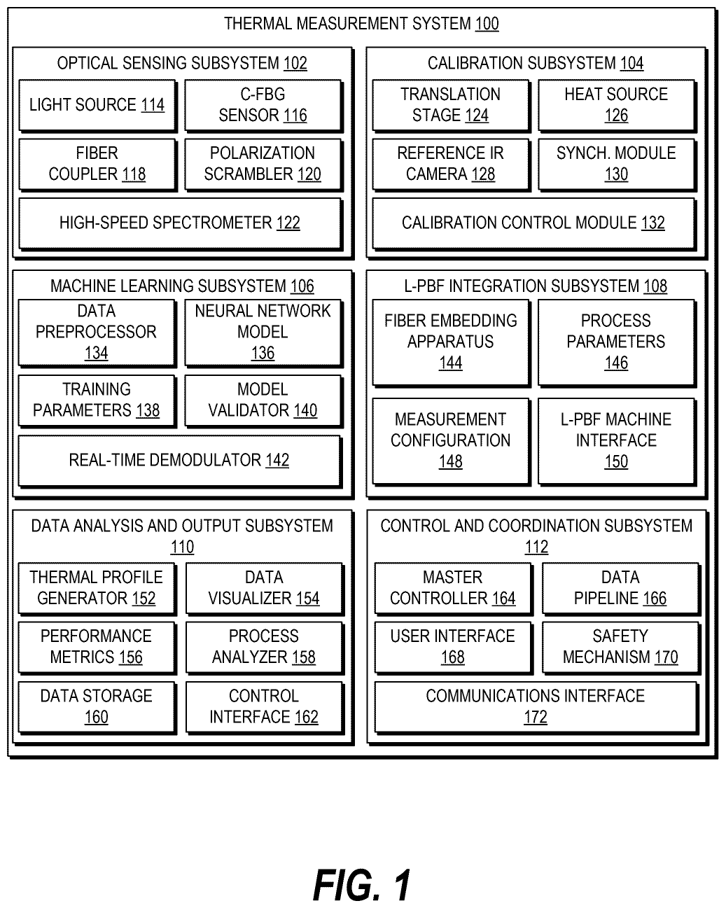

FIG. 1 depicts a thermal measurement system 100 for high spatial resolution sub-surface thermal measurement in additive manufacturing processes according to an example implementation. The thermal measurement system 100 addresses several challenges in laser powder bed fusion (L-PBF) monitoring, including the need for high-spatial-temporal resolution measurements, complex signal demodulation, sensor survivability at extreme temperatures, and effective embedding techniques. The thermal measurement system 100 can achieve spatial resolution of about 28.8 μm per pixel and a temporal resolution of up to 10 kHz through the integration of chirped fiber Bragg grating (C-FBG) sensors, machine learning-assisted demodulation, and automated calibration capabilities.

The thermal measurement system 100 enables direct measurement of reheating and re-melting phenomena in L-PBF processes, where deposited layers experience complex thermal cycling from subsequent layer deposition. Unlike existing approaches that rely on computational models with simplified assumptions, the thermal measurement system 100 provides experimental validation data for understanding microstructure evolution. In the illustrated example, the thermal measurement system 100 includes an optical sensing subsystem 102, a calibration subsystem 104, a machine learning subsystem 106, an L-PBF integration subsystem 108, a data analysis and output subsystem 110, and a control and coordination subsystem 112.

The thermal measurement system 100 can be implemented through various combinations of hardware and software components. Each subsystem can include one or more processors for executing computational tasks, memory devices for storing data and program instructions, and specialized hardware components tailored to specific functions. Software components can include firmware embedded in hardware devices, operating system software for managing computing resources, application software for implementing measurement and analysis algorithms, and driver software for interfacing with hardware components.

The thermal measurement system 100 can also incorporate mechanical components such as precision positioning stages, mounting fixtures, optical alignment mechanisms, and thermal management elements. The distribution of functionality between hardware and software can vary based on performance specifications, with time-critical operations such as real-time signal processing potentially implemented in dedicated hardware (such as field-programmable gate arrays or application-specific integrated circuits) while higher-level analysis functions may execute on general purpose processors. This flexible architecture enables optimization of each subsystem for specific performance specifications while maintaining overall system integration and reliability.

The optical sensing subsystem 102 implements a C-FBG-based measurement approach that improves spatial resolution without sacrificing sensing frequency. In the illustrated example, the optical sensing subsystem 102 includes a light source 114, a C-FBG sensor 116, a fiber coupler 118, a polarization scrambler 120, and a high-speed spectrometer 122.

The light source 114 can provide broadband optical radiation with specifications selected to match the operational wavelength range of a C-FBG sensor 116 and providing spectral coverage for high resolution measurements. For example, the light source 114 may provide broadband optical radiation centered around about 840 nanometers (nm) with approximately 50 nm of spectral width, selected to provide coverage across the C-FBG operational wavelength range while avoiding water absorption bands that could attenuate signals in humid environments.

The C-FBG sensor 116 can be fabricated using femtosecond laser point-by-point (fs-PbP) inscription methodology, which uses ultra-short laser pulses focused at discrete points to create permanent refractive index modifications through structural glass changes. This fabrication approach ensures sensor survivability at extreme temperatures, with operational capabilities exceeding 1000° C. compared to traditional ultra-violet-inscribed gratings that typically degrade above 300° C. The C-FBG sensor 116 can include a chirped fiber Bragg grating with millimeter scale length (e.g., 3 millimeters), multiple reflection orders (such as 5th order for enhanced reflectivity), and a center wavelength in the near-infrared range (e.g., 855 nm). The chirped structure incorporates a linear variation in grating period along the fiber length, with chirp rates on the order of several nanometers per centimeter (such as 3.33 nm/cm), enabling spatial encoding of temperature information.

The fiber coupler 118 can include a bidirectional optical coupling device with equal power splitting characteristics, enabling simultaneous delivery of interrogation light to the C-FBG sensor 116 and collection of reflected signals through a single optical path. The fiber coupler 118 can maintain a balanced splitting ratio (e.g., 50:50) to optimize both illumination intensity and reflection signal strength.

The polarization scrambler 120 can employ high-speed polarization state randomization to eliminate polarization-dependent variations in the C-FBG reflection spectrum. By continuously varying the polarization state of the propagating light at rates exceeding the measurement frequency, the polarization scrambler 120 averages out polarization-induced spectral features that could mask temperature-induced spectral changes, ensuring measurement stability and accuracy regardless of fiber bending or environmental perturbations.

The high-speed spectrometer 122 can analyze the wavelength content of light reflected from the C-FBG sensor 116. The spectrometer 122 can separate incoming light into component wavelengths and measures the intensity at each wavelength, producing a spectrum that shows how the reflected light varies across the wavelength range. For C-FBG sensing, the spectrometer 122 can capture how the reflection spectrum of the C-FBG sensor 116 changes with temperature, as different positions along the chirped grating reflect different wavelengths. The spectrometer 122 can operate at acquisition rates, such as 70 kHz with appropriate exposure times (e.g., 80 microseconds) to track rapid temperature changes during laser scanning, while providing wavelength resolution (i.e., sub-nanometer) to distinguish small spectral shifts corresponding to temperature variations. The wavelength range of the spectrometer 122 can be selected to cover the full operational band of the C-FBG sensor 116 to account for both the base reflection wavelengths of the grating and the wavelength shifts induced by temperature changes across the measurement range.

The calibration subsystem 104 can generate training data for machine learning models (e.g., a neural network model 136 described below) by creating controlled thermal profiles on the C-FBG sensor 116 while simultaneously capturing ground truth temperature measurements. The calibration subsystem 104 enables precise characterization of the relationship between C-FBG spectral response and spatial temperature distribution, which is used for accurate thermal profile reconstruction. In the illustrated example, the calibration subsystem 104 includes a translation stage 124, a heat source 126, a reference infrared (IR) camera 128, a synchronization module 130, and a calibration control module 132.

The translation stage 124 can provide precision positioning capability for creating varied thermal profiles along the C-FBG sensor 116. The translation stage 124 can include a multi-axis positioning system with micrometer level resolution (such as 1 μm) in both horizontal and vertical directions. This precise positioning control enables systematic variation of heating location and intensity to generate diverse training datasets covering the full range of expected thermal conditions.

The heat source 126 can generate controlled thermal profiles for calibration. The heat source 126 can include a resistive heating element, such as nichrome wire, with temperature control achieved through a regulated power supply. The heat source 126 can produce temperatures ranging from ambient to high temperatures (e.g., 23° C. to 800° C.) to encompass the full operational range of L-PBF processes. The thin wire configuration enables creation of localized heating patterns that simulate the sharp thermal gradients encountered during laser processing.

The reference IR camera 128 can capture ground truth thermal measurements of the C-FBG sensor 116 during calibration. The reference IR camera 128 can provide thermal imaging with spatial resolution matching or exceeding the target system resolution (such as 28.8 μm per pixel) at frame rates for dynamic thermal measurements (e.g., 100 Hz). The reference IR camera 128 can establish the spatial resolution limit for the overall system, as the machine learning model learns to reconstruct thermal profiles matching the reference IR camera 128 observations.

The synchronization module 130 can coordinate simultaneous data acquisition from the spectrometer 122 and the reference IR camera 128. The synchronization module 130 can ensure temporal alignment between spectral measurements and thermal images, creating paired datasets where each C-FBG spectrum corresponds to a known thermal profile. This synchronized acquisition is used for training machine learning models to accurately map spectral features to spatial temperature distributions.

The calibration control module 132 can automate the calibration process to generate comprehensive training datasets. The calibration control module 132 can coordinate translation stage movements, heat source temperature settings, and data acquisition timing to systematically explore the parameter space. For example, the calibration control module 132 can execute movement patterns including horizontal scanning across the C-FBG sensor 116, distance cycling to vary heating intensity, and temperature ramping to cover the full measurement range. The calibration control module 132 can generate multiple synchronized datasets with varying conditions to ensure robust model training across diverse thermal scenarios.

The machine learning subsystem 106 can process complex C-FBG reflection spectra to extract high-resolution spatial temperature profiles. The machine learning subsystem 106 addresses the challenge of demodulating fs-PbP inscribed C-FBG signals, which exhibit more spectral complexity than traditional C-FBG sensors due to fabrication-induced variations in the refractive index profile. In the illustrated example, the machine learning subsystem 106 includes a data preprocessor 134, a neural network model 136, training parameters 138, a model validator 140, and a real-time demodulator 142.

The data preprocessor 134 can condition raw spectral data from the spectrometer 122 for neural network processing. The data preprocessor 134 can perform normalization to account for light source intensity variations, noise reduction to improve signal quality, and feature extraction to convert variable-length spectra into fixed-dimension input arrays. The data preprocessor 134 standardizes spectral data into arrays with elements to capture the full spectral detail while maintaining consistent input dimensions for the neural network. For example, an 800 element array can effectively represent a 40 nm wavelength range with 0.05 nm resolution per element, providing adequate sampling density to capture temperature-induced wavelength shifts as small as 0.1 nm while preserving the complex spectral features of fs-PbP inscribed C-FBG sensors while enabling efficient neural network processing. This standardization ensures that spectral information from different measurement conditions can be processed by the same trained model.

The neural network model 136 implements the core transformation from spectral data to spatial temperature profiles. The neural network model 136 can employ a fully-connected deep neural network architecture optimized for regression tasks. For instance, the neural network can include three hidden layers with progressively reduced dimensions (e.g., 700, 600, and 500 nodes) to extract increasingly abstract features from the spectral data. The neural network can transform the preprocessed spectral input (e.g., a 1 by 800 array) into a high-resolution thermal profile output (such as a 1 by 480 array), corresponding to spatial positions along the C-FBG sensor 116, where each output element represents temperature at locations spaced approximately 6 μm apart.

The training parameters 138 define the optimization approach for the neural network model 136. The training parameters 138 can include selection of activation functions (such as Rectified Linear Unit (ReLU) for non-linear transformation), optimization algorithms (e.g., stochastic gradient descent), learning rate schedules (e.g., starting at 8e-2), batch sizes for gradient computation (such as 50 samples), and loss functions for measuring prediction accuracy (e.g., mean squared error). The training parameters 138 can be selected to achieve rapid convergence while maintaining model stability and generalization capability.

The model validator 140 can assess the performance of the neural network model 136 using test datasets not seen during training. The model validator 140 can compute various performance metrics including intersection over union (IOU) for profile shape accuracy, measuring the overlap between predicted and actual thermal profiles, correlation coefficients for overall agreement with ground truth, mean absolute error for temperature accuracy, and relative error for percentage-based assessment. For example, the model validator 140 can achieve IOU values exceeding 0.96 for the C-FBG region of interest, correlation above 0.99, and mean absolute errors below 13° C., confirming the capability of the neural network model 136 for accurate thermal profile reconstruction.

The real-time demodulator 142 can apply the neural network model 136 to process live spectral data during manufacturing operations. The real-time demodulator 142 can leverage hardware acceleration, such as graphics processing units (GPUS), to achieve desirable processing latencies (e.g., below 10 milliseconds). This rapid processing enables the thermal measurement system 100 to track dynamic thermal events during L-PBF processing, where melt pools can form and solidify within milliseconds. The real-time demodulator 142 maintains full model fidelity while operating at speeds compatible with closed-loop process control specifications.

The L-PBF integration subsystem 108 enables incorporation of the C-FBG sensor 116 into additive manufacturing processes while maintaining sensor integrity and measurement accuracy. The L-PBF integration subsystem 108 addresses challenges of sensor embedding, process compatibility, and real-time data acquisition during high-temperature manufacturing operations. In the illustrated example, the L-PBF integration subsystem 108 includes a fiber embedding apparatus 144, process parameters 146, a measurement configuration 148, and an L-PBF machine interface 150.

The fiber embedding apparatus 144 provides the equipment and procedures for installing the C-FBG sensor 116 within build substrates. The fiber embedding apparatus 144 can include wire electrical discharge machining (EDM) equipment for creating precision slots with dimensions on the order of hundreds of micrometers (e.g., about 300 μm width and 355 μm depth), metallic wires for gap filling that match the substrate composition, and the embedding procedure that coordinates these elements. The fiber embedding apparatus 144 implements an embedding process that creates minimal disruption to part integrity while ensuring reliable thermal contact. After slot creation, a compatible metallic wire fills the gap between fiber and substrate, followed by powder layer application and laser melting for encapsulation. The resulting strain-free mounting ensures thermal measurements are not influenced by mechanical stresses. This embedding process enables the fiber to remain in place throughout the manufacturing and service life of the part, creating components with integrated sensing capabilities.

The process parameters 146 define the L-PBF operating conditions during thermal measurement. The process parameters 146 can include laser power settings, scanning velocities, layer thickness specifications, and hatch spacing patterns. The process parameters 146 directly influence the thermal fields experienced by the embedded sensor and should be coordinated with the capabilities of the thermal measurement system 100 to ensure accurate data capture during dynamic thermal events.

The measurement configuration 148 specifies the spatial and temporal aspects of thermal data acquisition. The measurement configuration 148 can define sensor placement depth below the build surface, measurement area coverage, and data acquisition rates synchronized with process dynamics. The measurement configuration 148 accounts for the relationship between sensor position and the thermal fields of interest, optimizing placement to capture near-surface temperature gradients while maintaining sensor survivability.

The L-PBF machine interface 150 provides bidirectional communication between the thermal measurement system 100 and additive manufacturing equipment. The L-PBF machine interface 150 can include hardware connections for trigger signals, data synchronization protocols to align thermal measurements with laser scanning patterns, and software interfaces for process parameter exchange. The L-PBF machine interface 150 enables real-time coordination between manufacturing operations and thermal measurement, facilitating applications such as process monitoring, quality assessment, and eventual closed-loop control based on thermal feedback.

The data analysis and output subsystem 110 processes demodulated thermal measurements to generate actionable information for process monitoring and control. The data analysis and output subsystem 110 transforms raw thermal profiles into visualizations, metrics, and feedback signals that enable understanding and optimization of the L-PBF process. In the illustrated example, the data analysis and output subsystem 110 includes a thermal profile generator 152, a data visualizer 154, performance metrics 156, a process analyzer 158, a data storage 160, and a control interface 162.

The thermal profile generator 152 reconstructs spatial temperature distributions from the demodulated C-FBG sensor data. The thermal profile generator 152 can map the neural network output array (e.g., 1 by 480 elements) to physical positions along the sensor, applying calibration factors to convert relative measurements to absolute temperatures. The generator 152 can produce thermal profiles with micrometer-level spatial resolution (e.g., 28.8 μm per pixel) at acquisition rates matching the spectrometer sampling frequency (e.g., 10 kHz). This combination of high spatial and temporal resolution enables capture of steep thermal gradients and rapid temperature changes characteristic of L-PBF processes.

The data visualizer 154 creates real-time displays of thermal information for process monitoring. The data visualizer 154 can generate various visualization formats including spatial temperature maps showing instantaneous thermal distributions, time-temperature histories for specific locations along the sensor, gradient maps highlighting regions of rapid temperature change, and three-dimensional representations combining spatial and temporal data. The data visualizer 154 can update displays at rates compatible with human observation while maintaining full-resolution data for detailed analysis.

The performance metrics 156 quantify thermal characteristics relevant to microstructure formation. The performance metrics 156 can calculate maximum temperatures reached during processing, cooling rates at different locations along the sensor, thermal gradients in both spatial and temporal dimensions, and heat accumulation effects from multiple laser passes. For example, the metrics can detect thermal gradients up to 4×10⁵ degrees Celsius per meter (° C./m) and cooling rates up to 3500° C./m, providing quantitative data for correlation with microstructure evolution.

The process analyzer 158 correlates thermal measurements with process parameters and quality outcomes. The process analyzer 158 can identify relationships between thermal histories and microstructure characteristics, detect anomalous thermal patterns indicating potential defects, assess the effects of process parameter variations on thermal fields, and generate recommendations for process optimization. This analysis provides insights into the fundamental physics of the L-PBF process and enables data-driven process improvement.

The data storage 160 archives thermal measurements and associated metadata for subsequent analysis. The data storage 160 can implement efficient storage formats for high-volume time-series data, maintain synchronization between thermal data and process parameters, enable rapid retrieval of specific datasets for comparison or review, and support batch processing for comprehensive analysis across multiple builds. The data storage 160 can be configured to balance data fidelity with storage efficiency, preserving full-resolution data for regions of interest while applying appropriate compression elsewhere.

The control interface 162 provides pathways for implementing closed-loop process control based on thermal feedback. The control interface 162 can generate control signals based on thermal measurements, communicate with L-PBF equipment controllers to adjust process parameters, implement safety interlocks based on temperature thresholds, and enable adaptive processing strategies that respond to measured thermal conditions. The control interface 162 can transform the thermal measurement system 100 from a monitoring tool to an active component of process control, enabling optimization of part quality through thermal management.

The control and coordination subsystem 112 manages overall operation of the thermal measurement system 100 and ensures synchronized performance across all subsystems of the thermal measurement system 100. The control and coordination subsystem 112 orchestrates data flow, maintains timing relationships, and provides operational interfaces for system control and monitoring. In the illustrated example, the control and coordination subsystem 112 includes a master controller 164, a data pipeline 166, a user interface 168, a safety mechanism 170, and a communications interface 172.

The master controller 164 coordinates activities across all subsystems to maintain synchronized operation. The master controller 164 can manage timing relationships between optical measurements and thermal imaging, coordinate data acquisition with L-PBF process events such as layer starts and laser scanning patterns, orchestrate calibration sequences for system validation, and handle system state transitions between calibration, measurement, and standby modes. The master controller 164 can ensure that all subsystems operate in concert to achieve reliable thermal measurements during dynamic manufacturing processes.

The data pipeline 166 manages high-bandwidth data flow between subsystems while maintaining temporal alignment. The data pipeline 166 can implement buffering strategies to accommodate varying processing speeds across subsystems, maintain timestamp synchronization for correlating measurements with process events, enable parallel processing paths for real-time display and detailed analysis, and provide flow control to prevent data loss during peak processing loads. For example, to support high-speed operation at 10 kHz sampling rates with 800-element spectra the data pipeline 166 can be designed to handle sustained data rates exceeding 6 megabytes per second (MB/s) while preserving measurement fidelity and temporal alignment.

The user interface 168 enables operator interaction with the thermal measurement system 100. The user interface 168 can provide controls for system configuration including measurement parameters and operating modes, real-time display of system status and thermal measurements, access to historical data and analysis tools, and adjustment of visualization parameters for process monitoring. The user interface 168 can balance comprehensive functionality with intuitive operation, enabling both routine monitoring and detailed investigation of thermal phenomena.

The safety mechanism 170 can monitor system health and implements protective measures when necessary. The safety mechanism 170 can track sensor temperature to prevent damage from excessive heat exposure, monitor optical power levels to ensure safe operation, detect anomalous signals indicating potential sensor damage or disconnection, and implement shutdown procedures to protect equipment during fault conditions. Given the extreme temperatures encountered in L-PBF processes, the safety mechanism 170 is configured to preserve sensor integrity and measurement reliability.

The communications interface 172 can provide connectivity for system integration and remote operation. The communications interface 172 can support standard protocols for integration with manufacturing execution systems, enable remote monitoring and control capabilities for distributed operations, facilitate data export to external analysis platforms, and provide programming interfaces for custom applications and research tools. The communications interface 172 can support both real-time data streaming for process monitoring and bulk data transfer for comprehensive analysis, enabling the thermal measurement system 100 to function as part of larger manufacturing ecosystems.

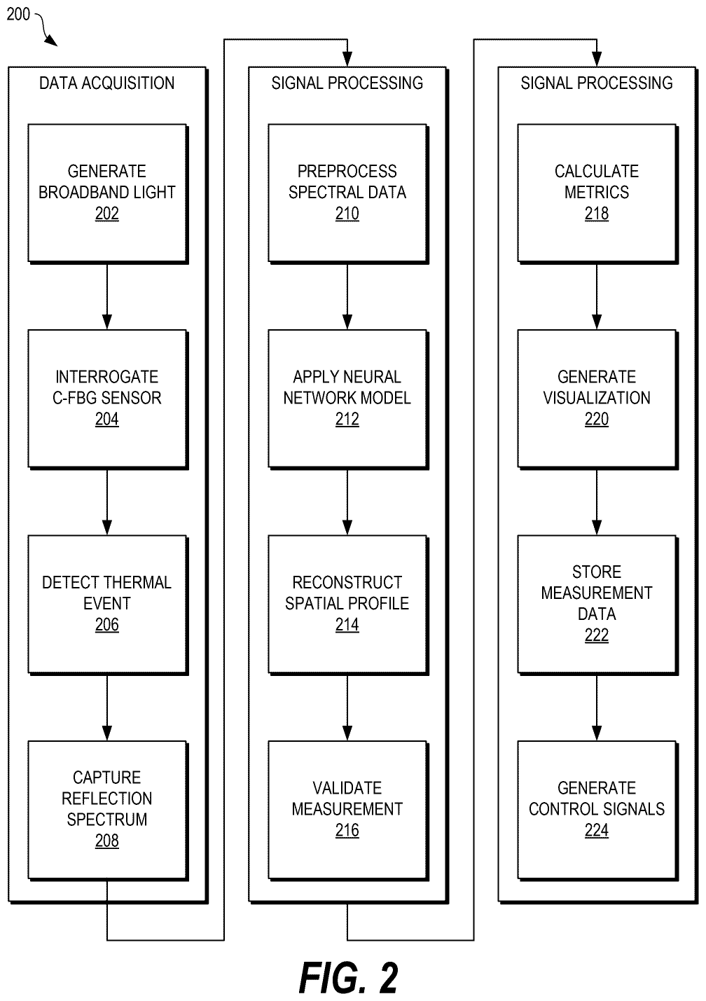

FIG. 2 depicts a method 200 for high spatial resolution thermal measurement in additive manufacturing processes using the thermal measurement system 100 of FIG. 1, according to an example implementation. The method 200 represents an example operational flow of the thermal measurement system 100, showing the progression from optical signal generation through thermal profile reconstruction to process feedback generation. It should be understood that the operations of the method 200 are not necessarily presented in any particular order and that performance of some or all of the operations in an alternative order(s) is possible and is contemplated. The operations have been presented in the demonstrated order for ease of description and illustration. Operations may be added, omitted, and/or performed simultaneously, without departing from the scope of the appended claims.

The method 200 begins with data acquisition operations performed by the optical sensing subsystem 102. At operation 202, the light source 114 generates broadband optical radiation with specifications suitable for C-FBG interrogation, such as 840 nm center wavelength with 50 nm spectral width. At operation 204, the optical signal interrogates the C-FBG sensor 116 through the fiber coupler 118, where light propagates through the chirped grating structure and temperature variations modulate the reflection spectrum at different positions along the grating. At operation 206, thermal events from the L-PBF process create temperature changes in the sub-surface region where the C-FBG sensor 116 is embedded. At operation 208, the high-speed spectrometer 122 captures the modulated reflection spectrum at sampling rates that can track rapid thermal dynamics, such as 70 kHz in one example implementation.

Signal processing operations performed by the machine learning subsystem 106 transform the spectral data into spatial temperature information. At operation 210, the data preprocessor 134 normalizes the spectral intensity, reduces noise, and extracts features into a fixed-dimension array suitable for neural network processing, such as a 1 by 800 element array. At operation 212, the neural network model 136 processes the preprocessed spectrum through multiple hidden layers to transform spectral features into a spatial temperature profile, outputting an array such as 1 by 480 elements with processing times under 10 milliseconds using the real-time demodulator 142. At operation 214, the method 200 reconstructs the spatial temperature profile by mapping array elements to physical positions along the C-FBG sensor 116, achieving spatial resolution such as 28.8 μm per pixel in one example implementation. At operation 216, the model validator 140 performs validation checks to ensure measurement quality by verifying temperature range validity and profile continuity.

Output generation operations performed by the data analysis and output subsystem 110 produce actionable information from the thermal measurements. At operation 218, the performance metrics 156 calculate thermal gradients such as up to 4×10⁵° C./m and cooling rates up to 3500° C./s in one example implementation. At operation 220, the data visualizer 154 generates real-time thermal maps and time-temperature histories for process monitoring. At operation 222, the data storage 160 archives measurement data and associated metadata for subsequent analysis and process optimization. At operation 224, the control interface 162 generates control signals for process parameter feedback and quality alerts based on the thermal measurements.

The method 200 can be repeated as needed throughout the additive manufacturing process to capture thermal measurements at different time points, layer positions, or process conditions. Each execution of the method 200 provides a complete thermal profile measurement, enabling continuous monitoring during L-PBF operations. By repeating the method 200 at appropriate intervals using the control and coordination subsystem 112, the thermal management system 100 captures the complex thermal history experienced by each layer as subsequent layers are deposited, building a comprehensive dataset for process optimization and quality control.

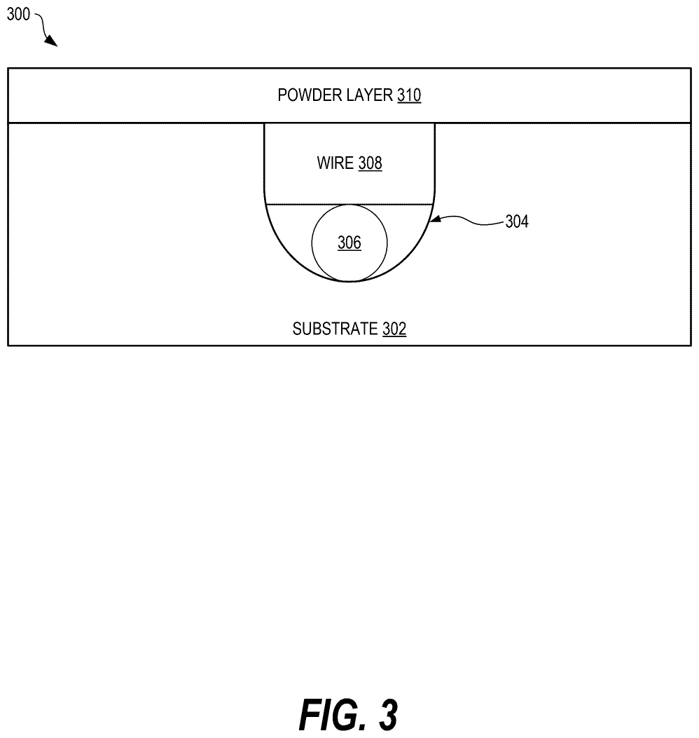

FIG. 3 depicts a cross-sectional view of a fiber embedding configuration 300 according to an example implementation. The fiber embedding configuration 300 shows the arrangement of components for strain-free mounting of the C-FBG sensor 116 within a substrate for sub-surface thermal measurement during additive manufacturing processes.

The fiber embedding configuration 300 includes a substrate 302, which can be formed from materials suitable for L-PBF processing such as Ti-64 titanium alloy. In one example implementation, the substrate 302 has a thickness of about 3.175 mm. A slot 304 can be formed in the substrate 302 using wire EDM to avoid introducing thermal stresses or heat-affected zones. A fiber 306 (e.g., the C-FBG sensor 116 in FIG. 1) is positioned within the slot 304. In one example implementation, the fiber 306 has a diameter of 125 μm, which is typical for single-mode optical fibers used in high-temperature sensing applications.

A wire 308 fills the space above the fiber 306 within the slot 304. In one example implementation, the wire 308 has a width of about 300 μm and is formed from the same material as the substrate 302 (such as Ti-64 titanium alloy) to ensure matched thermal expansion characteristics. This material matching prevents differential thermal expansion that could induce strain in the fiber 306 during high-temperature processing. A powder layer 310 having covers the assembly. The powder layer 310 can be of the same material as the substrate 302 and the wire 308 to ensure metallurgical compatibility during subsequent laser melting. In one example implementation, the powder layer 310 has a thickness of about 100 μm.

The dimensional relationships in the fiber embedding configuration 300 position the fiber 306 at a controlled depth below the top surface of the powder layer 310. For example, with a 100 μm powder layer 310 and appropriate slot depth, the fiber 306 can be positioned at about 230 μm below the final surface after consolidation through laser melting. This sub-surface positioning places the fiber 306 in a location suitable for measuring thermal fields during L-PBF processing while protecting the fiber 306 from direct laser exposure. The depth can be adjusted based on measurement specifications and material characteristics. The wire 308 provides mechanical support and thermal coupling between the fiber 306 and surrounding material while maintaining strain isolation through the controlled gap geometry.

After laser melting by the L-PBF system and surface polishing, the fiber embedding configuration 300 creates a robust embedded sensor arrangement. The fiber 306 remains in a strain-free condition throughout the embedding process and subsequent manufacturing operations. The consolidated structure allows the fiber 306 to measure thermal gradients and cooling rates in the sub-surface region where microstructure formation occurs, enabling real-time process monitoring and control during additive manufacturing. The fiber embedding configuration 300 can be replicated at multiple locations within the substrate 302 and/or adapted for different measurement depths by adjusting the slot geometry and wire dimensions.

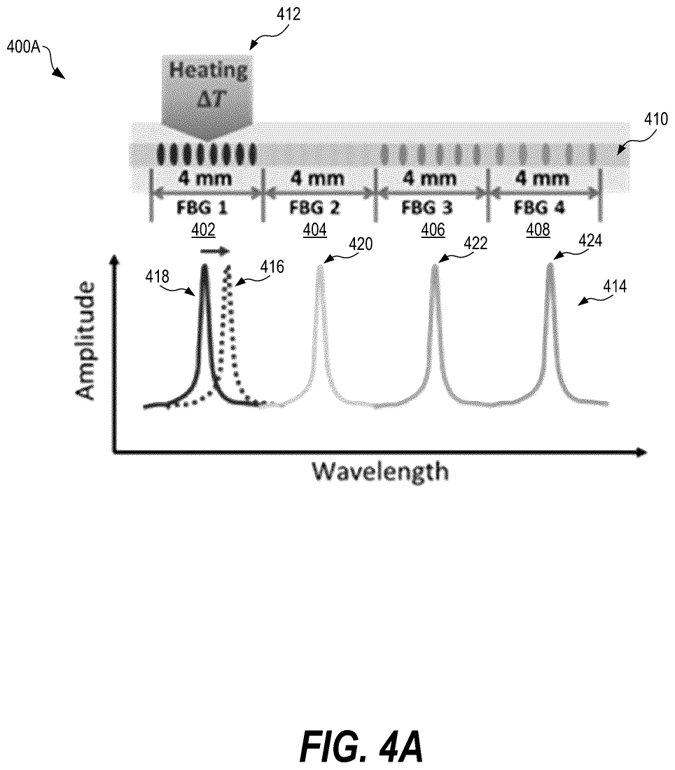

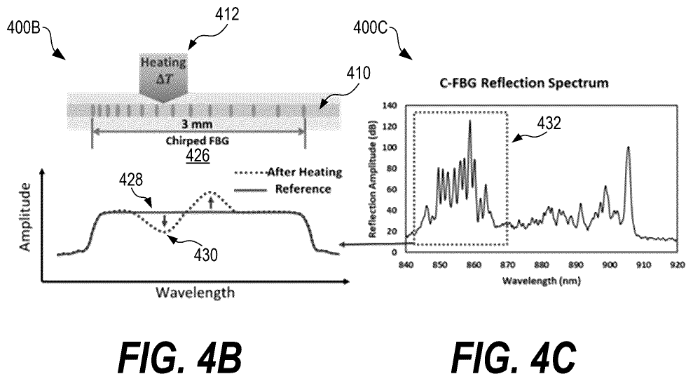

FIG. 4A depicts the operating principle of traditional FBG sensors 400A for temperature measurement. The illustrated configuration shows four discrete FBG sensors 402, 404, 406, and 408 (labeled as FBG 1, FBG 2, FBG 3, and FBG 4) positioned along an optical fiber 410 with 4 mm spacing between adjacent sensors. Each FBG consists of a uniform periodic modulation of the refractive index within the fiber core, causing each FBG sensor to reflect light at a specific wavelength determined by the grating period.

When a heating source 412 creates a temperature change (ΔT) at the location of the FBG sensor 402 (FBG 1), only that sensor experiences a wavelength shift in a corresponding reflection spectrum 414. The spectrum 414 shows an original reflection peak 418 (solid line) for the FBG sensor 402 (FBG 1) and a shifted reflection peak 416 (dotted line) resulting from the temperature change. The wavelength shift occurs due to thermal expansion of the grating and temperature-dependent changes in the refractive index. The remaining FBG sensors 404, 406, and 408 (FBG 2, FBG 3, and FBG 4) remain unaffected by the localized heating, maintaining associated original reflection wavelengths as shown by unshifted peaks 420, 422, and 424 respectively in the spectrum 414.

This traditional FBG configuration 400A demonstrates fundamental limitations for high-resolution thermal measurement in additive manufacturing applications. First, the spatial resolution is limited by the physical spacing between sensors, typically several millimeters. Second, each FBG sensor requires a length of several millimeters to achieve sufficient reflectivity, preventing closer spacing. Third, temperature information is only available at discrete points rather than continuously along the fiber 410. These limitations make traditional FBG sensors unsuitable for capturing the steep thermal gradients and micrometer-scale thermal features characteristic of L-PBF processes, where melt pools can be as small as 100 micrometers and thermal gradients can exceed 106° C./m.

FIG. 4B depicts a C-FBG sensor configuration 400B demonstrating continuous spatial temperature measurement capabilities. The C-FBG sensor configuration 400B includes a single C-FBG sensor 426 extending along a 3 mm length of an optical fiber 410. Unlike the uniform grating periods in traditional FBGs, the C-FBG sensor 426 incorporates linearly varying grating periods along its length, resulting in different Bragg wavelengths at different positions along the optical fiber 410. This chirped structure enables spatial information to be encoded directly in the reflection spectrum.

When the heating source 412 applies a temperature change (ΔT) to a localized region of the C-FBG sensor 426, the resulting thermal perturbation modifies the local refractive index through the thermo-optic effect and changes the local grating period through thermal expansion. A reference spectrum 428 represents the baseline reflection profile under uniform temperature conditions. The presence of localized heating produces a spectral modification 430 in the reflected spectrum. Because each position along the C-FBG sensor 426 corresponds to a specific wavelength, this spectral modification directly encodes the spatial location of the temperature change. This enables extraction of an intra-FBG thermal profile with spatial resolution determined by the spectral resolution of the interrogation system rather than physical sensor spacing.

FIG. 4C depicts an experimental C-FBG reflection spectrum 400C acquired from a femtosecond laser point-by-point (fs-PbP) inscribed sensor. The spectrum 400C spans a wavelength range from 840 nm to 920 nm and exhibits significant ripples and amplitude variations characteristic of fs-PbP inscription. While fs-PbP inscription enables operation at temperatures up to 1000° C., the resulting spectral complexity differs substantially from the smoother profiles produced by UV exposure and phase mask inscription methods.

A highlighted region 432 within the spectrum 400C exemplifies the complex spectral features that encode spatial temperature information. These ripples and variations prevent effective demodulation using existing model-based methods developed for smoother C-FBG spectra. The spectral complexity can be understood using the machine learning approach implemented by the neural network model 136 (FIG. 1), which learns to decode these fs-PbP C-FBG spectral patterns through training on synchronized spectral and thermal imaging data from the calibration subsystem 104. This data-driven approach enables extraction of high-resolution thermal profiles from complex spectra that would otherwise be incapable of demodulation using traditional signal processing techniques.

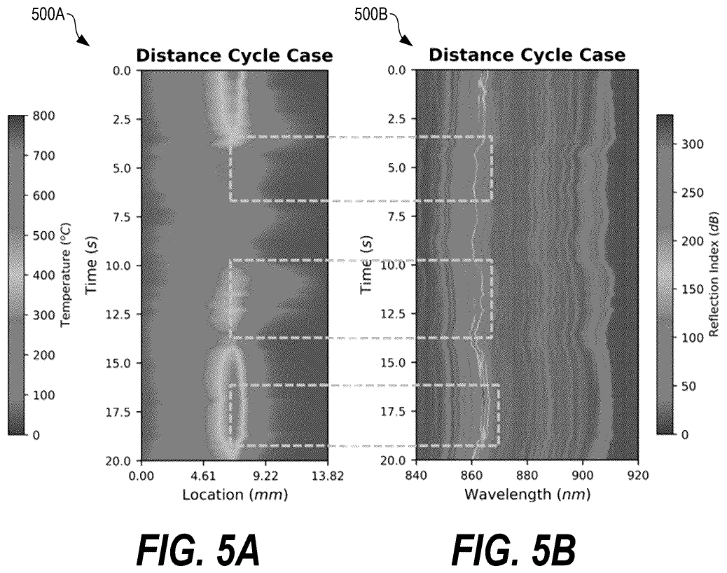

FIG. 5A depicts a thermal profile visualization 500A generated during calibration of the thermal measurement system 100 according to an example implementation. The thermal profile visualization 500A represents thermal data acquired by the reference IR camera 128 during a distance cycle calibration sequence, where the heat source 126 moves toward and away from the C-FBG sensor 116 to create varying thermal distributions. The horizontal axis represents physical location along the C-FBG sensor 116 in millimeters, spanning from 0.00 to 13.82 mm in the illustrated example. The vertical axis represents time in seconds over a 20-second acquisition period. Temperature values are encoded by grayscale intensity, with the scale ranging from 0° C. to 800° C.

The thermal profile visualization 500A shows the evolution of temperature along the C-FBG sensor 116 over the 20-second acquisition period. The hottest temperatures, reaching up to 800° C. as indicated by the darkest regions, appear at the center location of the sensor, which corresponds to the experimental configuration where the heat source 126 was positioned at the center of the C-FBG sensor 116. The temperature varies cyclically over time, decreasing and then ramping back up as designed for the distance cycle calibration sequence. This cycling creates varying thermal distributions—from sharp, concentrated peaks when the heat source 126 is close to the C-FBG sensor 116, to broader, lower-intensity distributions when the heat source 126 is positioned farther away. Some fluctuations in the thermal pattern result from air circulation disturbing the surrounding airflow near the fiber.

FIG. 5B depicts a corresponding C-FBG reflection spectrum visualization 500B acquired simultaneously with the thermal profile data of FIG. 5A. The visualization 500B represents spectral data captured by the high-speed spectrometer 122 during the same distance cycle calibration sequence. The horizontal axis represents wavelength in nanometers, spanning from 840 to 920 nm. The vertical axis represents time in seconds, synchronized with the thermal profile data. The reflection index intensity is encoded by grayscale values ranging from 0 to 300 dB.

The spectrum visualization 500B exhibits complex spectral features that correlate with the thermal events shown in FIG. 5A. Dashed boxes highlight regions where spectral modifications align temporally with the thermal peaks observed in the thermal profile visualization 500A. These spectral modifications appear as variations in the reflection intensity pattern at wavelengths between approximately 860 and 880 nm. The correlation between thermal events and spectral features demonstrates the encoding of spatial temperature information within the C-FBG reflection spectrum. This synchronized dataset provides training data for the neural network model 136, enabling the neural network model 136 to learn the mapping between complex spectral patterns and spatial temperature distributions with the target resolution of 28.8 μm per pixel.

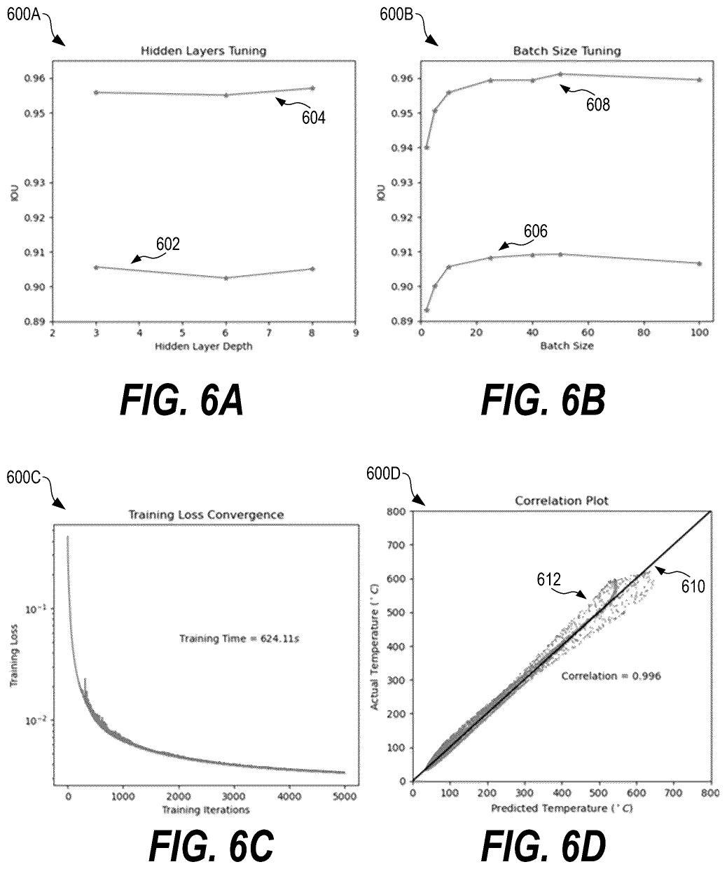

FIG. 6A depicts a hidden layer optimization graph 600A for the neural network model 136. The graph 600A shows the intersection over union (IOU) performance metric as a function of the number of hidden layers, ranging from 2 to 9 layers. An upper curve 604 represents the IOU performance for the C-FBG region of interest, maintaining values above 0.95 across all tested configurations. A lower curve 602 represents the IOU performance for the full field of view, showing values between 0.90 and 0.91. The configuration of three hidden layers provides high performance while minimizing computational complexity.

FIG. 6B depicts a batch size optimization graph 600B for training the neural network model 136. The graph 600B shows IOU performance as a function of batch size, ranging from 0 to 100 samples per batch. An upper curve 608 represents the C-FBG ROI performance, showing rapid improvement from batch size 0 to 20, then stabilizing above 0.96 for batch sizes of 50 and higher. A lower curve 606 represents the full ROI performance, following a similar improvement pattern but stabilizing around 0.91. A batch size of 50 samples provides suitable performance characteristics while maintaining efficient gradient computation during training.

FIG. 6C depicts a training loss convergence graph 600C showing the optimization progress of the neural network model 136. The training loss, computed as mean squared error between predicted and actual thermal profiles, decreases from an initial value of 10\hat{ }−1 to approximately 10\hat{ }−3 over 5000 training iterations. The rapid initial decrease followed by gradual convergence indicates stable model training. The training process completes in approximately 624.11 seconds using GPU acceleration, demonstrating practical training times for the machine learning subsystem 106.

FIG. 6D depicts a correlation plot 600D comparing predicted temperatures from the neural network model 136 against actual temperatures measured by the reference IR camera 128. Data points 610 cluster tightly along a 45-degree reference line 612, indicating strong agreement between predicted and measured values. The achieved correlation coefficient of 0.996 demonstrates the capability of the neural network model 136 to accurately reconstruct spatial temperature profiles from complex C-FBG reflection spectra. Temperature values span from 0° C. to 800° C., covering the full operational range suitable for L-PBF process monitoring.

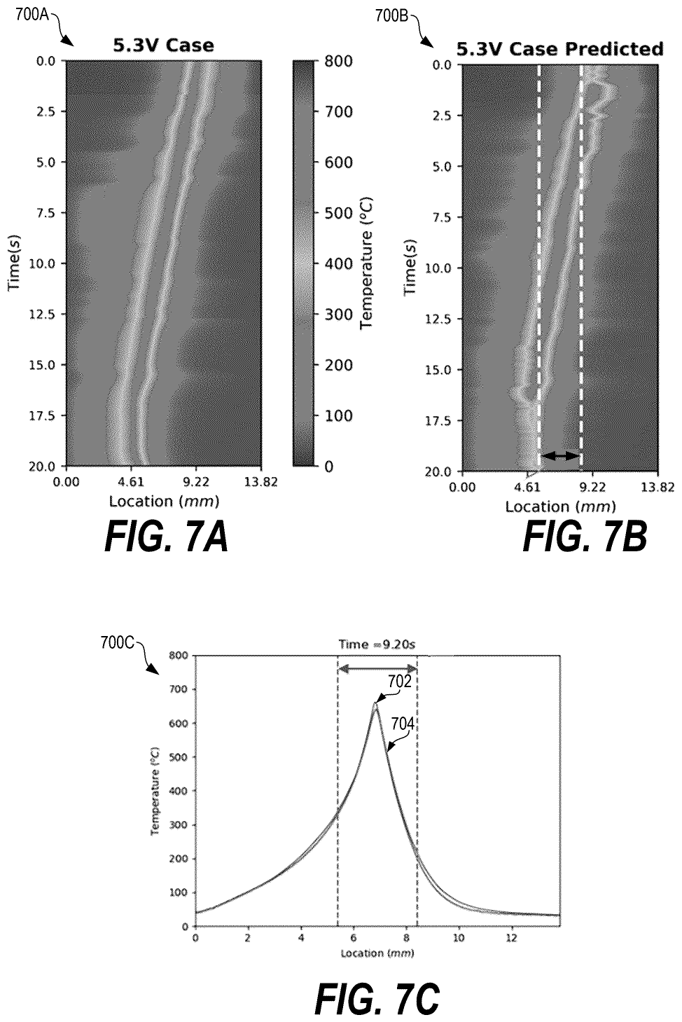

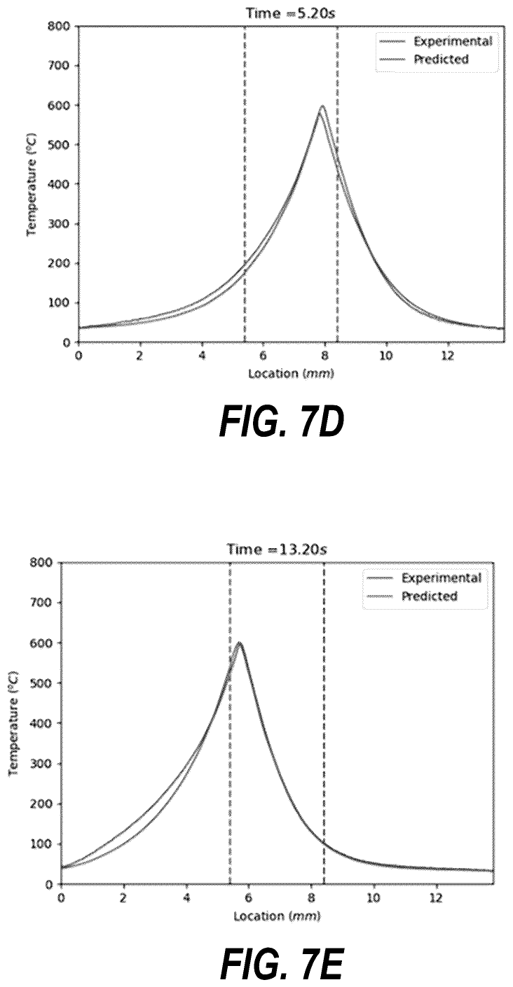

FIG. 7A depicts an experimental thermal profile visualization 700A acquired during validation testing of the thermal measurement system 100. The visualization 700A represents thermal data captured by the reference IR camera 128 during a horizontal moving calibration sequence with the heat source 126 powered at 5.3V DC. The horizontal axis represents physical location along the optical fiber from 0.00 to 13.82 mm, while the vertical axis represents time over a 20-second acquisition period. Temperature values are encoded by gray-scale intensity, ranging from 0° C. to 800° C. The diagonal thermal pattern indicates the heat source 126 moving horizontally along the C-FBG sensor 116, creating peak temperatures exceeding 700° C. at the heating location.

FIG. 7B depicts a machine learning-demodulated thermal profile visualization 700B generated by the neural network model 136 from C-FBG spectral data acquired simultaneously with the experimental data of FIG. 7A. The visualization 700B demonstrates the capability of the thermal measurement system 100 to reconstruct spatial temperature distributions from complex reflection spectra. Vertical dashed lines indicate the C-FBG sensor boundaries at approximately 4.61 mm and 9.22 mm, defining the C-FBG region of interest where demodulation accuracy is highest. The close correspondence between the experimental visualization 700A and the demodulated visualization 700B validates the performance of the neural network model 136.

FIG. 7C depicts a comparative thermal profile at time t=9.20 seconds showing the validation of the neural network model 136 performance. The graph 700C shows an experimental thermal profile 702 obtained from the reference IR camera 128 and a predicted thermal profile 704 generated by the neural network model 136 from the corresponding C-FBG reflection spectrum. Vertical dashed lines indicate the C-FBG sensor location boundaries at approximately 4.61 mm and 9.22 mm, defining the region where the C-FBG sensor 116 is positioned along the optical fiber 410. The thermal peak appears at approximately 7 mm with a maximum temperature near 650° C. The close agreement between experimental and predicted profiles within the C-FBG sensor location demonstrates the accuracy of the machine learning-based demodulation approach, particularly in capturing the sharp thermal gradient at the peak location.

FIG. 7D depicts a comparative thermal profile at time t=5.20 seconds, representing an earlier time point in the horizontal moving sequence. The thermal peak appears at approximately 6 mm location, demonstrating the leftward position of the heat source 126 at this earlier time. Peak temperatures reach approximately 600° C., with both experimental and predicted profiles showing strong agreement within the C-FBG sensor boundaries indicated by the vertical dashed lines.

FIG. 7E depicts a comparative thermal profile at time t=13.20 seconds, representing a later time point in the measurement sequence. The thermal peak has progressed to approximately 8 mm location, confirming the rightward movement of the heat source 126 along the C-FBG sensor 116. The continued agreement between experimental and predicted profiles across different time points and heating locations validates the robustness of the neural network model 136 in reconstructing spatial temperature distributions with the target resolution of 28.8 μm per pixel.

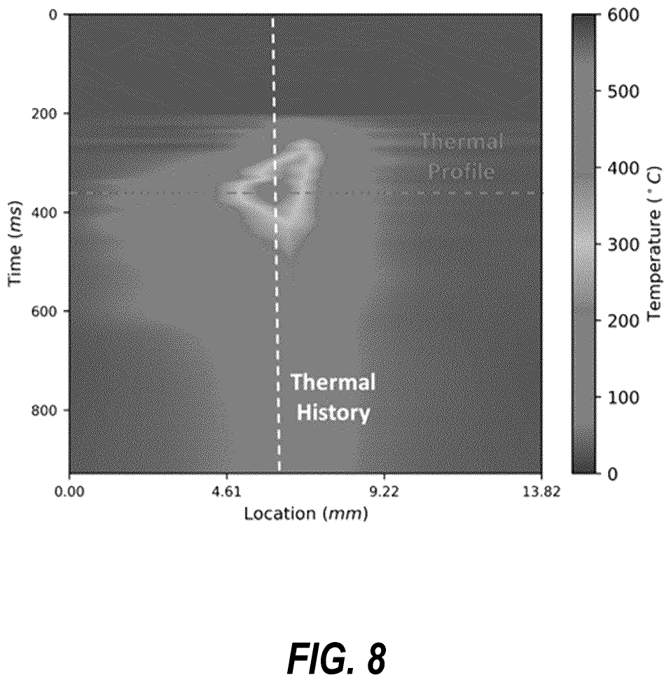

FIG. 8 depicts a sub-surface thermal measurement visualization 800 acquired during laser powder bed fusion processing using the thermal measurement system 100. The visualization 800 represents demodulated thermal data from the C-FBG sensor 116 embedded 230 μm below the build surface during L-PBF processing of a 2×4 mm² region. The horizontal axis represents physical location along the C-FBG sensor from 0.00 to 13.82 mm, while the vertical axis represents time in milliseconds over an 800 ms acquisition period. Temperature values are encoded by color intensity, ranging from 0° C. to 600° C.

The visualization 800 demonstrates the capability of the thermal measurement system 100 to capture complex thermal fields during additive manufacturing. A concentrated thermal region appears between approximately 200-400 ms centered around the 4.61 mm location, corresponding to the laser scanning pattern passing over the embedded sensor. Peak temperatures reach approximately 450° C. at the 230 μm sub-surface depth. A horizontal dashed line indicates the time instance for extracting spatial thermal profiles, while a vertical dashed line indicates the location for extracting temporal thermal histories.

The thermal field captured in the visualization 800 reveals critical process characteristics for L-PBF manufacturing. The measured thermal gradients reach 4×10⁵° C./m, approximately one order of magnitude smaller than surface melt pool gradients but still representing extreme thermal conditions. Cooling rates extracted from the thermal history data reach 3500° C./s, approximately three orders of magnitude smaller than melt pool cooling rates. These quantitative measurements, enabled by the 28.8 μm spatial resolution and 10 kHz temporal resolution of the thermal measurement system 100, provide unprecedented insight into sub-surface thermal conditions that directly influence microstructure formation during layer-wise additive manufacturing. The visualization 800 validates the system's capability to operate in actual L-PBF environments while maintaining measurement fidelity despite the extreme temperatures and rapid thermal cycling characteristic of the process.

The thermal measurement system 100 represents a significant advancement in additive manufacturing process monitoring by achieving unprecedented sub-surface thermal measurement capabilities through the novel integration of C-FBG sensors with machine learning-based signal processing. Unlike traditional fiber optic sensing approaches limited to millimeter-scale resolution with simple spectral patterns, the present disclosure enables successful demodulation of the complex reflection spectra characteristic of femtosecond laser-inscribed C-FBG sensors to achieve micrometer spatial resolution (e.g., 28.8 μm), an improvement of over one order of magnitude compared to traditional FBG systems. The neural network model 136 overcomes the fundamental limitation that has prevented the use of high-temperature-capable fs-PbP C-FBG sensors in precision thermal measurement applications by learning to decode the complex spectral signatures of C-FBG sensors through calibrated training datasets. This enables real-time monitoring of thermal gradients exceeding 4×10⁵° C./m and cooling rates up to 3500° C./s in the critical sub-surface region where microstructure formation occurs during layer-wise additive manufacturing. The combination of extreme temperature survivability (up to 1000° C.), high temporal resolution (10 kHz), and micrometer-scale spatial resolution provides researchers and manufacturers with previously unattainable insights into the thermal dynamics governing part quality in laser powder bed fusion processes, enabling data-driven optimization of additive manufacturing for critical applications.

The features, structures, or characteristics described above may be combined in one or more implementations in any suitable manner, and the features discussed in the various implementations are interchangeable, if possible. In the following description, numerous specific details are provided in order to fully understand the embodiments of the present disclosure. However, a person skilled in the art will appreciate that the technical solution of the present disclosure may be practiced without one or more of the specific details, or other methods, components, materials, and the like may be employed. In other instances, well-known structures, materials, or operations are not shown or described in detail to avoid obscuring aspects of the present disclosure.

As used in the specification including the appended claims, the singular forms “a,” “an,” and “the” include the plural, and reference to a particular numerical value includes at least that particular value, unless the context clearly dictates otherwise. Ranges may be expressed herein as from “about” or “approximately” one particular value and/or to “about” or “approximately” another particular value. When such a range is expressed, another implementation includes from the one particular value and/or to the other particular value. Similarly, when values are expressed as approximations, by use of the antecedent “about,” it will be understood that the particular value forms another implementation. As used herein, “about” means that a number, which is referred to as “about,” includes the recited number plus or minus 1-10% of that recited number.

The above-described implementations of the present disclosure are merely possible examples set forth for a clear understanding of the principles of the disclosure. Many variations and modifications may be made to the above-described implementations without departing substantially from the spirit and principles of the disclosure. All such modifications and variations are intended to be included herein within the scope of this disclosure and protected by the following claims.

1. A thermal measurement system for additive manufacturing processes, comprising:
an optical sensing subsystem comprising a chirped fiber Bragg grating (C-FBG) sensor configured to encode spatial temperature information in a reflection spectrum;
a machine learning subsystem comprising a neural network model configured to demodulate complex reflection spectra from the C-FBG sensor to generate spatial temperature profiles;
a calibration subsystem configured to generate training data by creating controlled thermal profiles on the C-FBG sensor while simultaneously capturing reference temperature measurements; and
a data acquisition system configured to capture reflection spectra from the C-FBG sensor during additive manufacturing operations.

2. The thermal measurement system of claim 1, wherein the C-FBG sensor is inscribed using a femtosecond laser point-by-point method.

3. The thermal measurement system of claim 2, wherein the C-FBG sensor is configured to operate at temperatures up to 1000° C.

4. The thermal measurement system of claim 1, wherein the spatial temperature profiles have a spatial resolution of at least 28.8 micrometers per pixel.

5. The thermal measurement system of claim 1, wherein the optical sensing subsystem comprises:
a broadband light source;
a fiber coupler configured to direct light to the C-FBG sensor and collect reflected light;
a polarization scrambler configured to minimize polarization-dependent variations in the reflection spectrum; and
a high-speed spectrometer configured to analyze the reflection spectrum.

6. The thermal measurement system of claim 5, wherein the high-speed spectrometer operates at a sampling rate of at least 10 kilohertz.

7. The thermal measurement system of claim 5, wherein the high-speed spectrometer has a maximum sampling rate of 70 kilohertz.

8. The thermal measurement system of claim 1, wherein the neural network model comprises a fully-connected neural network with at least three hidden layers.

9. The thermal measurement system of claim 8, wherein the neural network model employs a Rectified Linear Unit (ReLU) activation function and is optimized using stochastic gradient descent.

10. The thermal measurement system of claim 9, wherein the stochastic gradient descent uses a learning rate of 8e-2 and a batch size of 50.

11. The thermal measurement system of claim 1, wherein the calibration subsystem comprises:
a translation stage configured to position a heat source relative to the C-FBG sensor;
a heat source configured to create controlled thermal profiles;
a reference infrared camera configured to capture ground truth thermal measurements; and
a synchronization module configured to coordinate simultaneous acquisition of spectral and thermal data.

12. The thermal measurement system of claim 11, wherein the translation stage has a positioning resolution of at least 1 micrometer.

13. The thermal measurement system of claim 11, wherein the heat source comprises a resistive heating element capable of generating temperatures from ambient to 800° C.

14. The thermal measurement system of claim 1, further comprising an L-PBF integration subsystem comprising a fiber embedding apparatus configured to install the C-FBG sensor within build substrates.

15. The thermal measurement system of claim 14, wherein the fiber embedding apparatus comprises:
a wire electrical discharge machining system configured to create a slot in a substrate;
a metallic wire configured to fill a gap between the C-FBG sensor and the substrate; and
a laser powder bed fusion system configured to encapsulate the C-FBG sensor by melting a powder layer over a combination of the substrate, the metallic wire, and the C-FBG sensor.

16. The thermal measurement system of claim 15, wherein:
the slot has a width of approximately 300 micrometers and a depth of approximately 355 micrometers;
the metallic wire has a rectangular cross-section; and
the powder layer has a thickness of approximately 100 micrometers.

17. A method for thermal measurement in additive manufacturing processes, comprising:
generating broadband optical radiation;
directing the broadband optical radiation through a chirped fiber Bragg grating (C-FBG) sensor having a chirped grating structure that encodes spatial position information in wavelength;
detecting thermal events in a sub-surface region of a build substrate during additive manufacturing;
capturing a reflection spectrum from the C-FBG sensor, wherein the reflection spectrum contains spatially-encoded temperature information;
preprocessing the reflection spectrum to generate a fixed-dimension input array;
applying a neural network model to transform the reflection spectrum into a spatial temperature profile; and
outputting thermal measurements with micrometer-scale spatial resolution.

18. The method of claim 17, wherein the micrometer-scale spatial resolution is at least 28.8 micrometers per pixel.

19. The method of claim 17, further comprising training the neural network model by:
creating varied thermal profiles on the C-FBG sensor using a moveable heat source;
simultaneously capturing C-FBG reflection spectra and reference thermal images; generating paired training datasets of spectra and corresponding thermal profiles; and
optimizing neural network parameters to minimize prediction error.

20. The method of claim 17, further comprising embedding the C-FBG sensor in a substrate by:
creating a slot in the substrate using wire electrical discharge machining;
positioning the C-FBG sensor within the slot;
filling a gap above the C-FBG sensor with a metallic wire;
applying a powder layer over a combination of the substrate, the metallic wire, and the C-FBG sensor;
melting the powder layer using laser powder bed fusion; and
polishing a surface of the substrate to complete the embedding while maintaining the sensor in a strain-free condition.
